(19) United States
(12) Patent Application Publication
(10) Pub. No.: US 2023/0162514 A1
(43) Pub. Date: May 25, 2023

(54) INTELLIGENT RECOMMENDATION METHOD, VEHICLE-MOUNTED DEVICE, AND STORAGE MEDIUM

(71) Applicant: Mobile Drive Netherlands B.V., Amsterdam (NL)

(72) Inventor: CHENG-KUO YANG, New Taipei (TW)

(21) Appl. No.: 17/994,274

(22) Filed: Nov. 25, 2022

(30) Foreign Application Priority Data
Nov. 25, 2021 (CN) 202111415000.4

(51) Int. Cl. G06V 20/59; G06V 40/10; G10L 17/22; G10L 17/02; B60R 16/037

(52) U.S. Cl. CPC G06V 20/59; G06V 40/10; G10L 17/22; G10L 17/02; B60R 16/0373

(57) ABSTRACT

This application provides an intelligent recommendation method. The method includes capturing images of occupants in a vehicle using at least one camera, and obtaining attributes of occupants in the vehicle according to the captured images. Voice information of the occupants in the vehicle is collected using a microphone. Once the attributes of occupants in the vehicle and the voice information are sent to a cloud server, recommendation information can be obtained from the cloud server, wherein the recommendation information is generated based on a user intention that is obtained based on the attributes of occupants in the vehicle and the voice information.

### FIELD

The present disclosure relates to vehicle management technologies, in particular to an intelligent recommendation method, a vehicle-mounted device, and a storage medium.

### BACKGROUND

Many vehicles have vehicle-mounted voice assistants like Siri and Amazon Alexa. Drivers can communicate with the vehicle-mounted voice assistant through natural language and can control related functions of the vehicle-mounted device. However, when the vehicle-mounted voice assistant responds to the driver's voice command, the vehicle-mounted voice assistant does not consider occupants except the driver in the vehicle.

### BRIEF DESCRIPTION OF THE DRAWINGS

FIG. 1 is a diagram of one embodiment of an application environment of an intelligent recommendation method provided by the present disclosure.

FIG. 2 is a block diagram of one recommendation system provided by the present disclosure.

FIG. 3 is a block diagram of another recommendation system provided by the present disclosure.

FIG. 4 is a flowchart of a first embodiment of an intelligent recommendation method provided by the present disclosure.

FIG. 5 is a flowchart of a second embodiment of the intelligent recommendation method provided by the present disclosure.

FIG. 6 is a flowchart of a third embodiment of an intelligent recommendation method provided by the present disclosure.

FIG. 7 is a flowchart of a fourth embodiment of the intelligent recommendation method provided by the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

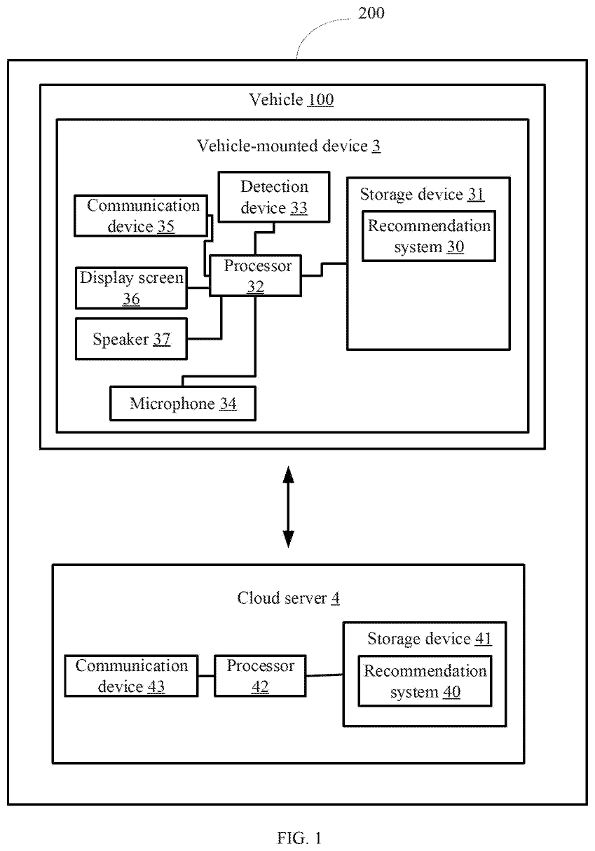

FIG. 1 illustrates a diagram of one embodiment of an application environment of an intelligent recommendation method provided by the present disclosure.

In this embodiment, the intelligent recommendation method is applied in an environment where an intelligent recommendation system 200 is formed by a vehicle-mounted device 3 and a cloud server 4 that are in communication with each other. The intelligent recommendation method is used for collecting voice information and attributes of occupants in a vehicle using the vehicle-mounted device 3, and identifying, at the cloud server 4, user intentions based on the voice information and attributes of occupants in the vehicle and performing, at the cloud server 4, relevant recommendations based on the user intentions. Details are described below.

In this embodiment, the vehicle-mounted device 3 is installed on a vehicle 100. The vehicle-mounted device 3 can also be called a vehicle-mounted computer, and includes a storage device 31, at least one processor 32, a detection device 33, a microphone 34, a communication device 35, a display screen 36, and a speaker 37 that are electrically connected to each other.

In this embodiment, the cloud server 4 includes a storage device 41, at least one processor 42, and a communication device 43. The cloud server 4 and the vehicle-mounted device 3 establish a communication connection through the communication device 43 and the communication device 35. The communication device 43 and the communication device 35 may be wireless communication devices.

Those skilled in the art should understand that the structures of the vehicle-mounted device 3 and the cloud server 4 shown in FIG. 1 do not constitute a limitation of the embodiments of the present disclosure, and the vehicle-mounted device 3 and the cloud server 4 may respectively include

More or snore fewer additional hardware or software, or have different arrangements of components. For example, the vehicle-mounted device 3 may also include a speed sensor and other devices. The cloud server 4 may also include a display screen and the like.

It should be noted that the vehicle-mounted device 3 and the cloud server 4 are only examples, and other existing or future vehicle-mounted devices and cloud servers that can be adapted to this disclosure should also be included within the protection scope of this disclosure, and be incorporated herein by reference.

In some embodiments, the storage device 31 and the storage device 41 may store program codes of computer programs and various data. For example, the storage device 31 can be used to store a recommendation system 30 installed in the vehicle-mounted device 3, and realize high-speed and automatic access to programs or data during an operation of the vehicle-mounted device 3. The storage device 41 can be used to store a recommendation system 40 installed in the cloud server 4, and realize high-speed and automatic access to programs or data during an operation of he cloud server 4. The storage device 31 and the storage device 41 may include Read-Only Memory (ROM), Programmable Read-Only Memory (PROM), Erasable Programmable Read-Only Memory (EPROM), One-time Programmable Read-Only Memory (OTPROM), Electronically Erasable Programmable Read-Only Memory (EEPROM), CD-ROM (Compact Disc Read-Only Memory) or other optical disk storage, magnetic disk storage, magnetic tape storage, or any other non-volatile computer-readable storage medium that can be used to carry or store data.

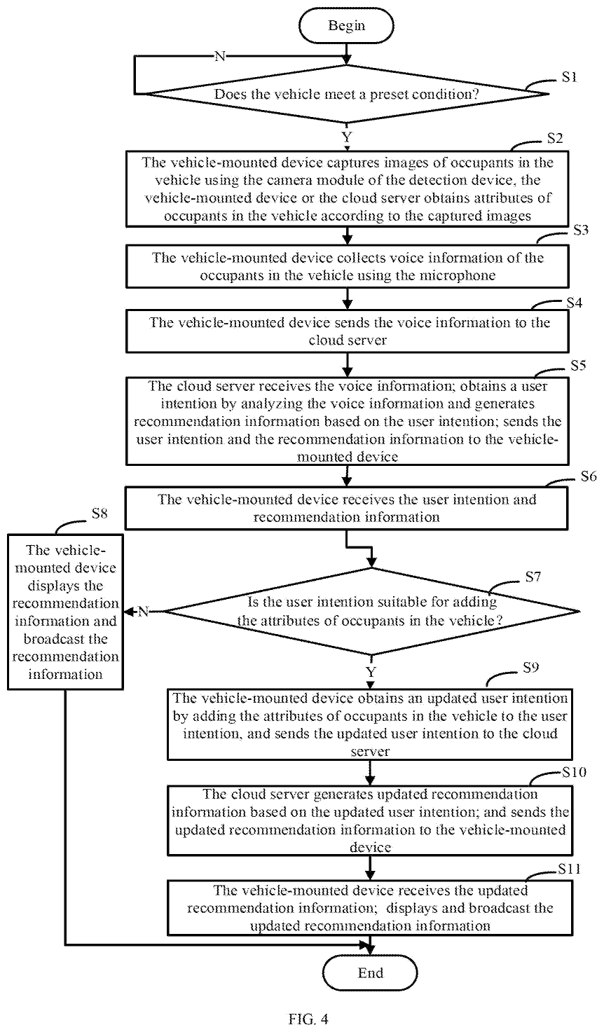

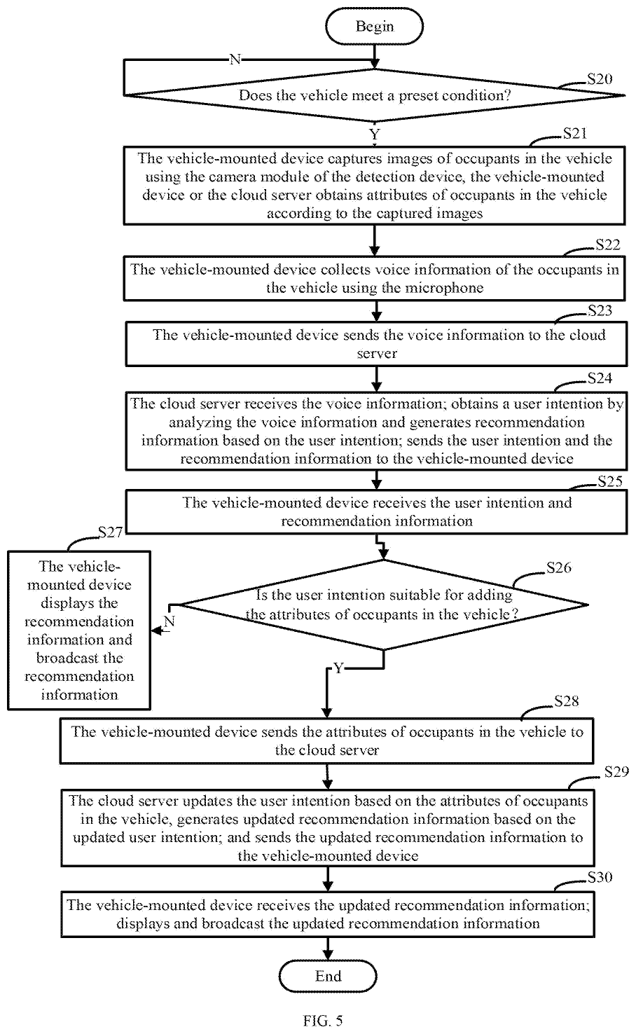

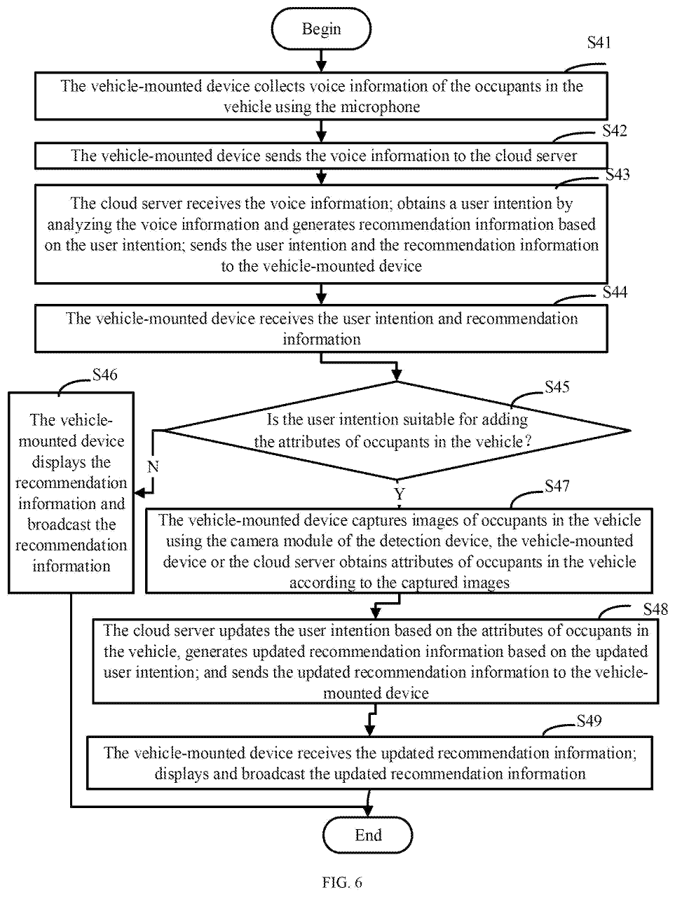

In some embodiments, the at least one processor 32 and the at least one processor 42 may each be comprised of integrated circuits. For example, each can be composed of a single packaged integrated circuit, or each can be composed of a plurality of integrated circuits packaged with the same function or different functions, including one or more central processing units (CPU), microprocessor controller, digital processing chip, graphics processor and combination of various control chips, etc. The at least one processor 32 is a control unit of the vehicle-mounted device 3, and uses various interfaces and lines to connect various components of the vehicle-mounted device 3, and executes programs or modules or instructions stored in the storage device 31, and invokes data stored in the storage device 31 to execute various functions and process data of the vehicle-mounted device 3, for example, to execute the function of intelligent recommendation (for details, please refer to FIG. 4, FIG. 5, and FIG. 6). The at least one processor 42 is a control unit of the cloud server 4, and uses various interfaces and lines to connect various components of the cloud server 4, and executes programs or modules or instructions stored in the storage device 41, and invoke the data stored in the storage device 41 to perform various functions and process data of the cloud server 4, for example, to perform the function of intelligent recommendation (for details, please refer to FIG. 4, FIG. 5, and FIG. 6).

In this embodiment, the detection device 33 includes, but is not limited to, one or more cameras (also referred to as “camera modules”), pressure sensors, ultrasonic sensors, and gravity sensors installed on the vehicle 100.

In this embodiment, the one or more cameras may be used to capture images of each occupant in the vehicle 100. The one or more cameras may also be used to capture images of a scene in front of the vehicle 100.

In this embodiment, the one or more cameras may include a 2D CMOS (Complementary Metal Oxide Semiconductor) camera with an infrared function or a ToF (Time of Flight) camera with a laser. The pressure sensor, ultrasonic sensor, or gravity sensor may be used to sense whether there is an occupant on the seats of the vehicle 100.

The microphone 34 may be used to collect voice information, for example, to collect the voice information of the occupants in the vehicle 100.

In this embodiment, the display screen 36 may be a touch display screen, which is used to display various data of the vehicle-mounted device 3, such as a user interface of the recommendation system 30. The speaker 37 can be used to output sound.

In the present embodiment, the recommendation system 30 can include one or more modules, and the one or more modules are stored in the storage device 31 and can be executed by one or more processors (e.g., the processor 32) to realize the functions provided by this disclosure. Referring to FIG. 2, in this embodiment, the recommendation system 30 may include a determination module 300, an acquisition module 301, and an execution module 302. A “module” as referred to in this disclosure is a segment of computer program capable of performing a specific function. The detailed functions of each module will be described below with reference to FIG. 4, FIG. 5, and FIG. 6.

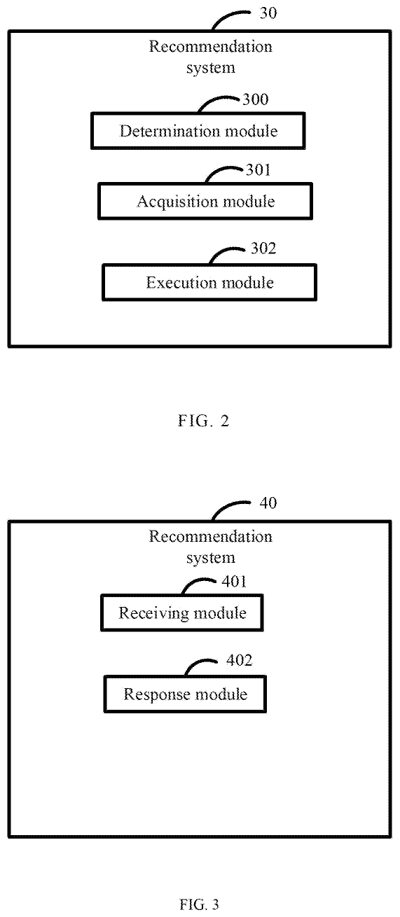

In this embodiment, the recommendation system 40 may include one or more modules, and the one or more modules are stored in the storage device 41 and processed by one or more processors (e.g., the processor 42) to realize the functions provided by this disclosure. Referring to FIG. 3, in this embodiment, the recommendation system 40 may include a receiving module 401 and a response module 402, The detailed functions of each module will be described below with reference to FIG. 4,

FIG. 5, and FIG. 6.

FIG. 4 is a flowchart of a first embodiment of an intelligent recommendation method provided by present disclosure.

In this embodiment, the intelligent recommendation method can be applied to an environment including the vehicle-mounted device 3 and the cloud server 4. For the vehicle-mounted device 3 and the cloud server 4 that need to perform intelligent recommendation, the functions for intelligent recommendation provided by this disclosure can be directly integrated on the vehicle-mounted device 3 and the cloud server 4, or in form of software development kits (SDK) running in the vehicle-mounted device 3 and the cloud server 4.

As shown in FIG. 4, the intelligent recommendation method includes the following blocks. According to different requirements, an order of the blocks in the flowchart can be changed, and some blocks can be omitted.

At block S1, the determination module 300 of the vehicle-mounted device 3 determines whether the vehicle 100 meets a preset condition. When the vehicle 100 meets the preset condition, the process goes to block S2.

In an embodiment, the vehicle 100 meeting preset conditions may include doors of the vehicle 100 being closed and/or an engine of the vehicle 100 is activated.

For example, when a door of the vehicle 100 is closed, a door lock detector of the vehicle-mounted device 3 (not shown in the figure sends a signal as to locking (hereinafter named as “lock signal”) to the vehicle-mounted device 3. Therefore, the determination module 300 can determine that the vehicle 100 meets the preset condition when the lock signal is detected. It should be noted that because passengers of the vehicle 100 may be on and off at many times, and may cause the vehicle 100 meets the preset condition at each time, then the blocks of this intelligent recommendation method can be executed at each time.

At block S2, the execution module 302 of the vehicle-mounted device 3 captures images of occupants in the vehicle 100 by using the camera module of the detection device 33, and obtains attributes of occupants in the vehicle 100 according to the captured images.

In one embodiment, the attributes of occupants in the vehicle 100 include, but are not limited to, a total number of occupants in the vehicle 100, an identity of a driver of the vehicle 100, an age and a gender of the driver. In one embodiment, the attributes of occupants in the vehicle 100 further includes identity information of each occupant, an age and a gender of each occupant, and a composition relationship of all occupants in the vehicle 100 (the composition relationship of all occupants in the vehicle 100 means a composition relationship of occupants currently in the vehicle 100).

In one embodiment, the composition relationship of all occupants in the vehicle 100 may refer to a relationship of lovers, a relationship of family, a relationship of parent-child, or another relationship such as a relationship of each being a stranger.

In this embodiment, when the vehicle 100 meets the preset condition, the execution module 302 may control the camera module of the detection device 33 to capture images of the occupants in the vehicle 100. The execution module 302 of the vehicle-mounted device 3 may determine the age and the gender of each occupant according to the captured images by using a gender and age recognition algorithm based on face of each occupant n the captured image. In one embodiment, the execution module 302 of the vehicle-mounted device 3 pre-stores in the storage device 41 the identity information of each occupant who has ever ridden in the vehicle 100, and the relationship between the occupants who have ever ridden in the vehicle 100. In one embodiment, the identity information of the occupant who have ever ridden in the vehicle 100 includes, but is not limited to, a name, a face image, a role (i.e., a driver or a passenger) of the occupant when in the vehicle 100, and a driving mode of the vehicle 100 when the occupant in the vehicle 100.

In one embodiment, driving modes of the vehicle 100 may include, but are not limited to, a normal mode, a sport mode, and a highway mode. In one embodiment, different driving modes have different requirements on power output of the vehicle 100. Wherein, the normal mode has the lowest requirement on the power output of the vehicle 100, the sport mode has a higher requirement on the power output of the vehicle 100, and the highway ode has the highest requirement on the power output of the vehicle 100.

In one embodiment, when the execution module 302 of the vehicle-mounted device 3 is not able to obtain the identity information of an occupant from the storage device 41, the execution module 302 determines that the occupant is a stranger. In one embodiment, the execution module 302 may use a face recognition algorithm to determine whether the occupant is a stranger based on a face image of the occupant pre-stored in the storage device 41 and the captured image of the occupant.

Specifically, the execution module 302 can obtain a face image of the occupant from the captured image of the occupant. When the execution module 302 recognizes that the obtained face image of the occupant does not match the face image of the occupant pre-stored in the storage device 41, the execution module 302 can determine that the occupant is a stranger. On the contrary, when the obtained face image of the occupant matches the face image of the occupant pre-stored in the storage device 41, the vehicle-mounted device 3 can determine that the occupant is an occupant who has ever ridden in the vehicle 100. Therefore, the vehicle-mounted device 3 can also obtain other identity information of a non-first-time occupant from the storage device 41 based on the obtained face image of the occupant, the other identity information of the non-first-time occupant may include the name, the role of the non-first-time occupant, the driving mode of the vehicle, and a relationship between the non-first-time occupant and other non-first-time occupants when the non-first-tine occupant previously in the vehicle 100, and the like.

In other embodiments, the execution module 302 of the vehicle-mounted device 3 may also obtain the image of the occupant in the vehicle 100 and send the obtained image of the occupant to the cloud server 4, and the cloud server 4 can confirm the attributes of occupants in the vehicle 100 based on the obtained image.

At block S3, the acquisition module 301 of the vehicle-mounted device 3 collects information as the voice (hereinafter named as “voice information”) of the occupants in the vehicle 100 using the microphone 34.

For example, when an occupant of the vehicle 100, such as a driver, says “Please recommend a nearby restaurant”, the microphone 34 can collect corresponding voice information.

At block S4, the execution module 302 of the vehicle-mounted device 3 sends the voice information to the cloud server 4 through the communication device 35.

At block S5, the receiving module 401 of the cloud server 4 receives the voice information through the communication device 43. The response module 402 of the cloud server 4 obtains a user intention by analyzing the voice information and generates recommendation information based on the user intention. The response module 402 sends the user intention and the recommendation information to the vehicle-mounted device 3 through the communication device 43.

In this embodiment, the response module 402 can first convert the voice information into text by using a voice recognition technology; and then analyze the text using an intention recognition algorithm such as a dictionary and template-based rule method to obtain the user intention.

For example, assuming that the voice information is “please recommend a nearby restaurant”, the response module 402 obtains the user intention as: “search”, “nearby restaurant” by using the intent recognition algorithm. The response module 402 obtains restaurant information within a preset distance such as 500 meters from a predetermined application (APP) such as a software of a Google map according to the user intention, namely “search” and “nearby restaurants”, and sets the restaurant information as the recommendation information.

At block S6, the acquisition module 301 of the vehicle-mounted device 3 receives the user intention and recommendation information through the communication device 35.

At block S7, the execution module 302 of the vehicle-mounted device 3 determines whether the user intention is suitable for adding the attributes of occupants in the vehicle 100. When it is determined that he user intention is not suitable for adding the attributes of occupants in the vehicle 100, the process goes to block S8. When it is determined that the user intention is suitable for adding the attributes of occupants in the vehicle 100, the process goes to block S9.

In one embodiment, the execution module 302 can determine whether the user intention is suitable for adding the attributes of occupants in the vehicle 100 in response to user input.

In one embodiment, the execution module 302 may generate a dialog box and display the dialog box on the display screen 36. The execution module 302 may determine whether the user intention is suitable for adding the attributes of occupants in the vehicle 100 according to user's selection on the dialog box.

For example, since the cloud server 4 currently recommends restaurants without considering the attributes of occupants in the vehicle 100, the recommended restaurants include many restaurants suitable for couples, but a composition relationship in the vehicle 100 is a relationship of parent-child, and such restaurant may not be a good choice. Accordingly, the user may select on the dialog and add the attributes of occupants in the vehicle 100. Of course, the execution module 302 can also determine whether the user intention is suitable for adding the attributes of occupants in the vehicle 100 by analyzing the user's voice input.

In other embodiments, the execution module 302 of the vehicle-mounted device 3 may pre-store various user intentions that are suitable for adding the attributes of occupants in the vehicle 100; when the received user intention matches any of the pre-stored user intentions, the execution module 302 determines that the received user intention is suitable for adding the attributes of occupants in the vehicle 100; when the received user intention does not match any of the pre-stored user intentions, the execution module 302 determines that the received user intention is not suitable for adding the attributes of occupants in the vehicle 100.

In this embodiment, the pre-stored user intentions may include keywords such as “restaurant”, “hotel”, or “scenic spots” which are related to human activities.

At block S8, when the user intention is not suitable for adding the attributes of occupants in the vehicle 100, the execution module 302 of the vehicle-mounted device 3 displays the recommendation information. The execution module 302 of the vehicle-mounted device 3 may also broadcast aloud the recommendation information.

For example, the execution module 302 may display the recommendation information on the display screen 36. The execution module 302 may invoke the speaker 37 to broadcast the recommendation information aloud.

At block S9, when the user intention is suitable for adding the attributes of occupants in the vehicle 100, the execution module 302 of the vehicle-mounted device 3 obtains an updated user intention by adding the attributes of occupants in the vehicle 100 to the user intention, and sending the updated user intention to the cloud server 4 through the communication device 35.

In other embodiments, the execution module 302 may obtain he updated user intention by only adding the composition relationship of all occupants in the vehicle 100 to the user intention. For example, the execution module 302 may obtain an updated user intention: “search”, “nearby restaurants”, and “parent-child” by adding the composition relationship of all occupants of the vehicle 100, such as the relationship of parent-child to the user intention. In one embodiment, if the execution module 302 only adds the composition relationship of all occupants of the vehicle 100 to the user intention, the execution module 302 may also send other attributes such as the identity information of the occupants in the vehicle 100 to the cloud server 4.

At block S10, the response module 402 of the cloud server 4 generates updated recommendation information based on the updated user intention. The response module 402 of the cloud server 4 also sends the updated recommendation information to the vehicle-mounted device 3 through the communication device 43.

For example, the response module 402 sends a number of restaurants suitable for the relationship of parent-child to the vehicle-mounted device 3 in a form of a recommendation list.

In one embodiment, the cloud server 4 pre-stores the identity information of each occupant who has ever ridded/has previously travelled in the vehicle 100, as well as preference information of each occupant.

In other embodiments, the response module 402 can obtain preference information of each occupant based on identity information of the each occupant.

In other embodiments, the response module 402 updates the recommendation information based on the updated user intention and the preference information of each occupant.

At block S11, the acquisition module 301 of the vehicle-mounted device 3 receives the updated recommendation information through the communication device 35. The execution module 302 of the vehicle-mounted device 3 can also display the updated recommendation information on the display screen 36. The execution module 302 of the vehicle-mounted device 3 can also broadcast the updated recommendation information using speaker 37.

FIG. 5 is a flowchart of a second embodiment of an intelligent recommendation method provided by present disclosure.

In this embodiment, the intelligent recommendation method can be applied to an environment including the vehicle-mounted device 3 and the cloud server 4. For the vehicle-mounted device. 3 and the cloud server 4 that need to perform intelligent recommendation, the functions of intelligent recommendation provided by this disclosure can be directly integrated on the vehicle-mounted device 3 and the cloud server 4, or in form of software development kits (SDK) running in the vehicle-mounted device 3 and the cloud server 4.

As shown in FIG. 5, the intelligent recommendation method includes the following blocks. According to different requirements, an order of the blocks in the flowchart can be changed, and some blocks can be omitted.

Block S20 is the same as block S1, and details are not repeated here.

Block S21 is the same as block S2, and details are not repeated here.

Block S22 is the same as block S3, and will not be repeated here.

Block S23 is the same as block S4, and details are not repeated here.

Block S24 is the same as block S5, and details are not repeated here.

Block S25 is the same as block S6, and details are not repeated here.

At block S26, the execution module 302 of the vehicle-mounted device 3 determines whether the user intention is suitable for adding the attributes of occupants in the vehicle 100. When it is determined that the user intention is not suitable for adding the attributes of occupants in the vehicle 100, the process goes to block S27. When it is determined that the user intention is suitable for adding the attributes of occupants in the vehicle 100, the process goes to block S28.

The determining as to whether the user intention is suitable for adding the attributes of occupants in the vehicle 100 is the same as that described in the foregoing block S7, and therefore will not be repeated.

Block S27 is the same as block S8, and details are not repeated here.

At block S28, when it is determined that the user intention is suitable for adding the attributes of occupants in the vehicle 100, the execution module 302 of the vehicle-mounted device 3 sends the attributes of occupants in the vehicle 100 to the cloud server 4 through the communication device 35.

At block S29, the response module 402 of the cloud server 4 updates the user intention based on the attributes of occupants in the vehicle 100, and generates updated recommendation information based on the updated user intention. The response module 402 of the cloud server 4 also sends the updated recommendation information to the vehicle-mounted device 3 through the communication device 43.

In one embodiment, the response module 402 obtains the updated user intention by adding the attributes of occupants in the vehicle 100 to the user intention.

In other embodiments, the response module 402 may only add the composition relationship of all occupants in the vehicle 100 to the user intention to obtain the updated user intention. For example, the response module 402 may add the composition relationship of all occupants in the vehicle 100, such as a relationship of parent-child, to the user intention to obtain the updated user intention such as: “search”, “nearby restaurants”, and “parent-child”.

At block S30, the obtaining module 301 of the vehicle-mounted device 3 receives the updated recommendation information through the communication device 35. The execution module 302 of the vehicle-mounted device 3 may also display the updated recommendation information on the display screen 36. The execution module 302 of the vehicle-mounted device 3 may also use the speaker 37 to broadcast the updated recommendation information.

It should be noted that a difference between the intelligent recommendation methods shown in FIG. 4 and FIG. 5 is that the intelligent recommendation method shown in FIG. 5 is that when it is determined that the user intention is suitable for adding the attributes of occupants in the vehicle 100, the cloud server 4 is used to update user intention and update recommendations based on the updated user intention. Since a computing power of the cloud server 4 is greater than that of the vehicle-mounted device 3, it can respond to the needs of the user more quickly.

FIG. 6 is a flowchart of a third embodiment of an intelligent recommendation method provided by present disclosure.

In this embodiment, the intelligent recommendation method can be applied to an environment including the vehicle-mounted device 3 and the cloud server 4. For the vehicle-mounted device 3 and the cloud server 4 that need to perform intelligent recommendation, the functions of intelligent recommendation provided by this disclosure can be directly integrated on the vehicle-mounted device 3 and the cloud server 4, or in form of software development kits (SDK) running in the vehicle-mounted device 3 and the cloud server 4.

As shown in FIG. 6, the intelligent recommendation method includes the following blocks. According to different requirements, an order of the blocks in the flowchart can be changed, and some blocks can be omitted.

Block S41 is the same as block S22, and details are not repeated here.

Block S42 is the same as block S23, and details are not repeated here.

Block S43 is the same as block S24, and details are not repeated here.

Block S44 is the same as block S25, and details are not repeated here.

At block S45, the execution module 302 of the vehicle-mounted device 3 determines whether the user intention is suitable for adding the attributes of occupants in the vehicle 100. When it is determined that the user intention is not suitable for adding the attributes of occupants in the vehicle 100, the process goes to block S46. When it is determined that the user intention is suitable for adding the attributes of occupants in the vehicle 100, the process goes to block S47.

The determining of whether the user intention is suitable for adding the attributes of occupants in the vehicle 100 is the same as that described in the foregoing blocks S7 and S26, and thus will not be repeated here.

Block S46 is the same as block S27, and details are not repeated here.

At block S47, the execution module 302 of the vehicle-mounted device 3 captures images of the occupants in the vehicle 100 using the camera module of the detection device 33, and confirms the attributes of occupants in the vehicle 100 according to the captured images, and transmits the attributes of occupants in the vehicle 100 to the cloud server 4 via the communication device 35.

It should be noted that, in this block S47, the capturing images of the occupants in the vehicle 100 using the camera module of the detection device 33, and confirming the attributes of occupants in the vehicle 100 according to the captured images is the same as that in block S2, details will not be repeated here. Block S48 is the same as block S29, and will not be repeated here.

Block S49 is the same as block S30, and will not be repeated here.

It should be noted that a difference between the intelligent recommendation method shown in FIG. 4 and FIG. 6 is that the intelligent recommendation method shown in FIG. 6 detects the attributes of occupants in vehicle 100 only when it is determined that the attributes of occupants in the vehicle 100 are suitable for adding to the user intention. Since the vehicle-mounted device 3 does not need to detect the attributes of occupants in vehicle 100 in advance, it does not need to detect the attributes of occupants in vehicle 100 when the attributes of occupants in vehicle 100 are not suitable for adding to the user intention, thus it saves data processing resources and responding to user needs more quickly.

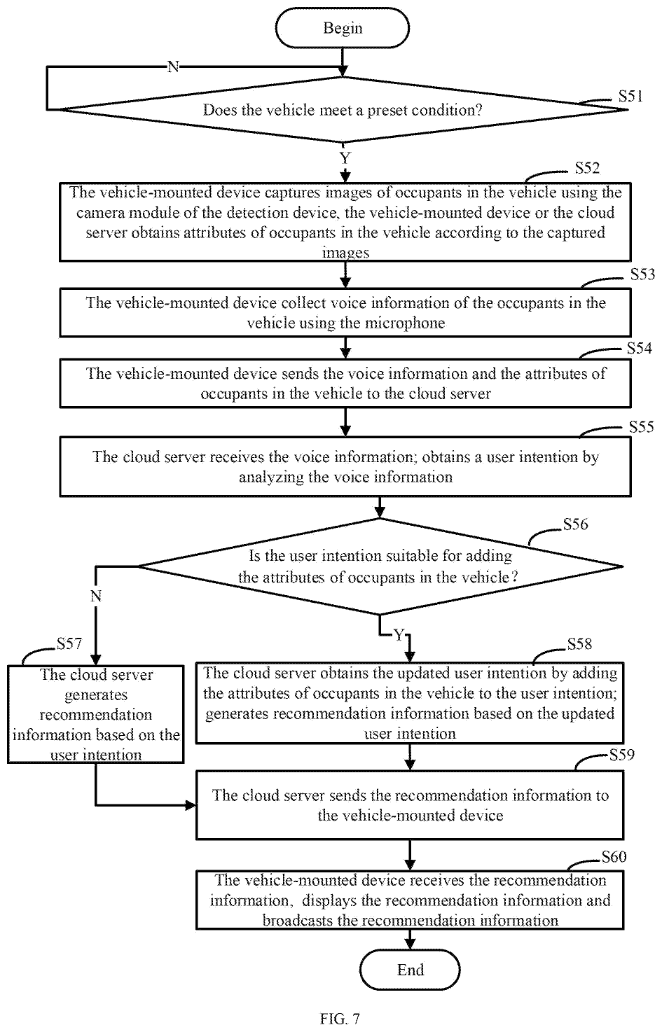

FIG. 7 is a flowchart of a fourth embodiment of an intelligent recommendation method provided by present disclosure.

In this embodiment, the intelligent recommendation method can be applied to an environment including the vehicle-mounted device 3 and the cloud server 4. For the vehicle-mounted device 3 and the cloud server 4 that need to perform intelligent recommendation, the functions of intelligent recommendation provided by this disclosure can be directly integrated on the vehicle-mounted device 3 and the cloud server 4, or in form of software development kits (SDK) running in the vehicle-mounted device 3 and the cloud server 4.

As shown in FIG. 7, the intelligent recommendation method includes the following blocks. According to different requirements, an order of the blocks in the flowchart can be changed, and some blocks can be omitted.

Block S51 is the same as block S1, and details are not repeated here.

Block S52 is the same as block S2, and details are not repeated here.

Block S53 is the same as block S3, and details are not repeated here.

At block S54, the vehicle-mounted device 3 sends the voice information and the attributes of occupants in the vehicle 100 to the cloud server 4.

At block S55, the receiving module 401 of the cloud server 4 receives the voice information through the communication device 43. The response module 402 of the cloud server 4 obtains user intention by analyzing the voice information.

At block S56, the response module 402 of the cloud server 4 determines whether the user intention is suitable for adding the attributes of occupants in the vehicle 100. When it is determined that the user intention is not suitable for adding the attributes of occupants in the vehicle 100, the process goes to block S57; when it is determined that the user intention is suitable for adding the attributes of occupants in the vehicle 100, the process goes to block S58.

In one embodiment, the cloud server 4 may pre-store various user intentions suitable for adding the attributes of occupants in the vehicle 100; if the obtained user intention matches a pre-stored user intention, it is determined that the obtained user intention is suitable for adding the attributes of occupants in the vehicle 100; if the obtained user intention does not match the pre-stored user intention, it is determined that the obtained user intention is not suitable for adding the attributes of occupants in the vehicle 100.

In this embodiment, the various user intentions suitable for adding the attributes of occupants in the vehicle 100 may include keywords related to people such as “restaurant”, “hotel”, or “scenic spots”.

At block S57, when it is determined that the user intention is not suitable for adding the attributes of occupants in the vehicle 100, the response module 402 of the cloud server 4 generates recommendation information based on the user intention. After block S57 is performed, the process goes to block S59.

At block S58, when it is determined that the user's intention is suitable for adding the attributes of occupants in the vehicle 100, the response module 402 of the cloud server 4 obtains the updated user intention by adding the attributes of occupants in the vehicle 100 to the user intention. The response module 402 of the cloud server 4 generates recommendation information based on the updated user intention.

At block S59, the response module 402 of the cloud server 4 sends the recommendation information to the vehicle-mounted device 3 through the communication device 43.

At block S60, the obtaining module 301 of the vehicle-mounted device 3 receives the recommendation information through the communication device 35. The execution module 302 of the vehicle-mounted device 3 may also display the recommended information on the display screen 36. The execution module 302 of the vehicle-mounted device 3 may also use the speaker 37 to broadcast the recommended information.

In the several embodiments provided in this disclosure, it should be understood that the devices and methods disclosed can be implemented by other means. For example, the device embodiments described above are only schematic. For example, the division of the modules is only a division according to logical function, which can be implemented in another way.

The modules described as separate parts may or may not be physically separate, and the parts displayed as modules may or may not be physical units, that is, may be located in one place, or may be distributed over multiple network units. Part or all of the modules can be selected according to the actual needs to achieve the purpose of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The above integrated modules implemented in the form of function modules may be stored in a storage medium. The above function modules may be stored in a storage medium, and include several instructions to enable a computing device (which may be a personal computer, server, or network device, etc.) or processor to execute the method described in the embodiment of the present disclosure.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but not to signify any particular order.

The above description is only embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. An intelligent recommendation method applied to a vehicle-mounted device and a cloud server,
the method comprising:
capturing, at the vehicle-mounted device, images of occupants in a vehicle using at least one camera, and obtaining attributes of occupants in the vehicle according to the captured images;
collecting, at the vehicle-mounted device, voice information of the occupants in the vehicle using a microphone;
sending the attributes of occupants in the vehicle and the voice information from the vehicle-mounted device to the cloud server;
obtaining, at the cloud server, a user intention based on the voice information;
obtaining, at the cloud server, an updated user intention based on the attributes of occupants in the vehicle, when the cloud server determining that the user intention is suitable for adding the attributes of occupants in the vehicle;
generating, at the cloud server, recommendation information based on the updated user intention, and sending the recommendation information to the vehicle-mounted device.

2. The method according to claim 1, wherein the attributes of occupants in the vehicle comprises a total number of occupants in the vehicle, an identity of a driver of the vehicle, an age and a gender of the driver.

3. The method according to claim 2, wherein the attributes of occupants in the vehicle further comprises identity information of each occupant, an age and a gender of each occupant, and a composition relationship of all occupants in the vehicle.

4. The method according to claim 1, further comprising:
capturing, at the vehicle-mounted device, the images of occupants in the vehicle when doors of the vehicle are closed.

5. The method according to claim 1, further comprising:
capturing, at the vehicle-mounted device, the images of occupants in the vehicle when an engine of the vehicle is activated.

6. The method according to claim 1, further comprising:
displaying, at a display device of the vehicle-mounted device, the recommendation information, when the user intention is not suitable for adding the attributes of occupants in the vehicle; or broadcasting, at the vehicle-mounted device, the recommendation information using a speaker.

7. The method according to claim 3, further comprising:
obtaining, at the cloud server, preference information of each occupant based on identity information of the each occupant; and
obtaining, at the cloud server, recommendation information based on the updated user intention and the preference information of each occupant.

8. The method according to claim 1, further comprising:
pre-storing, in a storage device of the vehicle-mounted device, identity information of each occupant who has ever ridden in the vehicle, and a relationship between the occupants who have ever ridden in the vehicle.

9. The method according to claim 8, wherein the identity information of the occupant who have ever ridden in the vehicle comprises a name, a face image, a role of the occupant when the occupant ridded the vehicle, and a driving mode of the vehicle when the occupant ridded the vehicle.

10. The method according to claim 9, wherein driving modes of the vehicle comprise a normal mode, a sport mode, and a highway mode, wherein, the normal mode has the lowest requirement on the power output of the vehicle, the sport mode has a higher requirement on the power output of the vehicle, and the highway mode has the highest requirement on the power output of the vehicle.

11. The method according to claim 10, further comprising:
determining, at the vehicle-mounted device, that the occupant is a stranger when the identity information of the occupant cannot be obtained from the storage device.

12. A vehicle-mounted device comprising:
a storage device;
at least one processor; and
the storage device storing one or more programs, which when executed by the at least one processor, cause the at least one processor to:
capture images of occupants in a vehicle using at least one camera, and obtain attributes of occupants in the vehicle according to the captured images;
collect voice information of the occupants in the vehicle using a microphone;
send the attributes of occupants in the vehicle and the voice information to a cloud server; and
obtain recommendation information from the cloud server, wherein the recommendation information is generated based on a user intention that is obtained based on the attributes of occupants in the vehicle and the voice information.

13. The vehicle-mounted device according to claim 12, wherein the attributes of occupants in the vehicle comprises a total number of occupants in the vehicle, an identity of a driver of the vehicle, an age and a gender of the driver.

14. The vehicle-mounted device according to claim 13, wherein the attributes of occupants in the vehicle further comprises identity information of each occupant, an age and a gender of each occupant, and a composition relationship of all occupants in the vehicle.

15. The vehicle-mounted device according to claim 12, wherein the at least one processor is further caused to:
capture the images of occupants in the vehicle when doors of the vehicle are closed.

16. The vehicle-mounted device according to claim 12, wherein the at least one processor is further caused to:
capture the images of occupants in the vehicle when an engine of the vehicle is activated.

17. The vehicle-mounted device according to claim 12, wherein the at least one processor is further caused to:
display, at a display device, the recommendation information, when the user intention is not suitable for adding the attributes of occupants in the vehicle; or broadcast the recommendation information using a speaker.

18. The vehicle-mounted device according to claim 12, wherein the at least one processor is further caused to:
pre-store, in the storage device, identity information of each occupant who has ever ridden in the vehicle, and a relationship between the occupants who have ever ridden in the vehicle.

19. The vehicle-mounted device according to claim 18, wherein the at least one processor is further caused to:
determine that the occupant is a stranger when the identity information of the occupant cannot be obtained from the storage device.

20. A non-transitory storage medium having stored thereon at least one computer-readable instructions, which when executed by a processor of a vehicle-mounted device, causes the processor to perform an intelligent recommendation method, wherein the method comprises:
capturing images of occupants in a vehicle using at least one camera, and obtaining attributes of occupants in the vehicle according to the captured images;
collecting voice information of the occupants in the vehicle using a microphone;
sending the attributes of occupants in the vehicle and the voice information to a cloud server; and
obtaining recommendation information from the cloud server, wherein the recommendation information is generated based on a user intention that is obtained based on the attributes of occupants in the vehicle and the voice information.
